(19) United States
(12) Patent Application Publication
(10) Pub. No.: US 2007/0024064 A1
(43) Pub. Date: Feb. 1, 2007

(54) Security device, use of a security device and a method of securing a handle

(76) Inventor: David Carter, Essex (GB)

Correspondence Address: GABLE & GOTWALS, 100 WEST FIFTH STREET, 10TH FLOOR, TULSA, OK, 74103, US

(21) Appl. No.: 10/546,567

(22) PCT Filed: Jan. 29, 2004
(86) PCT No.: PCT/GB04/00356

§ 371 Date: Jun. 21, 2006

(30) Foreign Application Priority Data
Feb. 21, 2003 (GB) 0304042.5

(51) Int. Cl. E05C 19/08

(52) U.S. Cl. 292/281

(57) ABSTRACT

The present invention relates to a security device (1) for securing a handle (7) to a clasp (8) so as to prevent operation of said handle (2), the security device comprising a first housing having a bolt (4) extending therefrom and a second housing (3) comprising retaining means (5) for receiving and retaining a distal end of the bolt to secure the first and second housings together; in a first state the first and second housings being separate from each other and separate from said handle to which the security device is to be secured; the first and second housings being assemblable into a second state in which the first and second housings are secured together by means of engagement of the bolt with the retaining means, wherein, in use, in the second state the security device may enclose at least a portion of said handle within an interior of the security device and wherein the bolt may pass through an aperture in the handle and an aperture in the clasp; wherein, in use, in the second state the second housing shrouds the retaining means and wherein, in use, in the second state the first and second housings shroud the clasp.

The present invention relates to a security device use of a security device and a method of securing a handle. In particular, the invention relates to a security device for securing the handles of cargo container doors or similar articles.

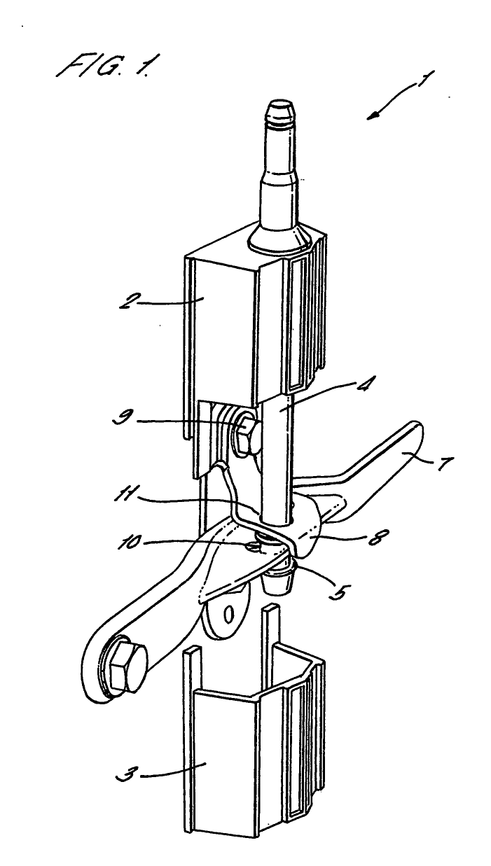

Cargo containers and similar articles are used widely for the transporting of goods from place to place. Often, the contents of the cargo containers can be valuable and there is thus a need to secure the contents during transport. The doors of cargo containers typically comprise a handle which is operated to open and close the cargo container door. A typical cargo container handle is shown as part of FIG. 1. The handle 7 is secured in place by a clasp 8 fixed to the cargo container door by means of a bolt 9. It is known to secure the clasp 8 to the handle 7 by means of a two-part security device of the type shown in FIG. 16 which comprises a first part in the fort of a bolt 60 having an enlarged upper end 61 and a second part in the form of a cap 62 which can be fixedly attached to an end 63 of the bolt 60. Thus, to secure the clasp 8 to the handle 7, the bolt 60 is passed through an aperture 11 in the clasp 8 and an aperture 10 in the handle 7 and the cap 62 is then fixedly secured to the end 63 of the bolt 60 preventing withdrawal of the bolt through the apertures 10 and 11. These types of security devices have a number of drawbacks including the ease with which they can be dismantled and replaced so that it is not immediately evident that tampering has taken place. Typically, the cap 62 is tampered with and broken and the bolt 60 removed from the apertures 10 and 11 allowing the cargo container door to be opened. Once the theft or other activity has taken place, the bolt is replaced in the apertures 10 and 11 and the cap 62 glued or otherwise fixed to the bolt 60 so that, from a cursory inspection, it appears that the security device is intact. Alternatively, the bolt 9 securing the clasp 8 to the container door may be broken allowing direct removal of the clasp 8. Again, afterwards the bolt head may be re-affixed giving the impression that no tampering has taken place.

The present invention seeks to provide an improved security device for locking items such as the handles of cargo container doors which overcomes the above drawbacks.

The present invention provides a security device
for securing a handle to a clasp so as to prevent operation of said handle, the security device comprising a first housing having a bolt extending therefrom and a second housing comprising retaining means for receiving and retaining a distal end of the bolt to secure the first and second housings together;
in a first state the first and second housings being separate from each other and separate from said handle to which the security device is to be secured;
the first and second housings being assemblable into a second state in which the first and second housings are secured together by means of engagement of the bolt with the retaining means, wherein, in use, in the second state the security device may enclose at least a portion of said handle within an interior of the security device and wherein the bolt may pass through an aperture in the handle and an aperture in the clasp;
wherein, in use, in the second state the second housing shrouds the retaining means and wherein, in use, in the second state the first and second housings shroud the clasp.

Advantageously, the first and second housings cannot be removed without first shearing through the bolt which cannot thereafter easily be replaced to give the impression that the security device is intact. The shrouding of the locking means by the second housing prevents direct tampering with the locking means which is a common failing of prior art security devices.

Preferably, the clasp, to which the security device is to be secured, is of a type which is fixed to a structure, such as a door, by means of a fixing, wherein in the second state, in use, the first and second housings shroud the fixing of the clasp.

Preferably, the retaining means comprises a barrel located in the second housing, the bolt comprising a locking means in the form of a retaining ring located on the bolt wherein passage of the retaining ring through the barrel is accommodated in only one direction.

The use of a retaining ring such as a circlip and a securing barrel provides for a fast method of securing the first and second housings together which does not require complicated tools or keys to operate.

Preferably, when the first and second housings are secured together the interior is bounded by an upper wall, a lower wall, side walls and a roof.

When the first and second housings are secured together the first and second housings preferably delimit an aperture through which, in use, shearing means may be brought into engagement with the bolt.

Thus, the only point at which the bolt can be sheared to remove the security device is at the pre-defined aperture. The aperture may be sized to prevent other items such as crowbars, being brought into engagement with the bolt.

In use, at least a portion of a member to be secured can extend from an exterior of the security device through the aperture into the interior of the first and second housings into engagement with the bolt.

Optionally, the first housing and bolt are secured together. This may be done by forming the bolt and first housing as one part or by fixing a separate bolt and first housing together after manufacture by welding or similar means. By securing the bolt and first housing together the number of separate parts that must be handled by a user is reduced making the device easier to use.

Preferably, the first and second housings comprise inter-engaging means to prevent relative rotation of the first and second housings about the bolt. This ensures that the first and second housings orientation relative to the member to be secured is known. As a consequence the size of the aperture can be minimised improving the security of the device.

Preferably, the first and second housings are axially slidable relative to one another to secure the first and second housings together.

Optionally, the security device further comprises an identification tag.

The present invention also provides a method of
securing a handle to a clasp
   comprising engaging a first housing and a second housing around at least a portion of the handle, wherein a bolt of the first housing is passed through at least one aperture formed in the handle and at least one aperture formed in the clasp and engaged in retaining means located in the second housing to secure the first and second housings together, wherein securement of the first and second housings together shrouds the retaining means and clasp.

The present invention also covers use of the security device as described above to secure a handle.

In one application the handle is the handle of a cargo container door. Preferably the bolt of the security device is passed through at least one aperture in the handle. Optionally, the handle of the cargo container door may comprise a clasp or similar secured to the door by a retaining means and wherein the security device in the secured position shrouds the retaining means.

An embodiment of the present invention will now be described, by way of example only, with reference to the accompanying drawings in which:-

FIG. 1 is a perspective view of a security device according to the present invention in an open configuration as applied to the handle of a cargo container door;

FIG. 2 is a perspective view of the security device of FIG. 1 in a secured configuration;

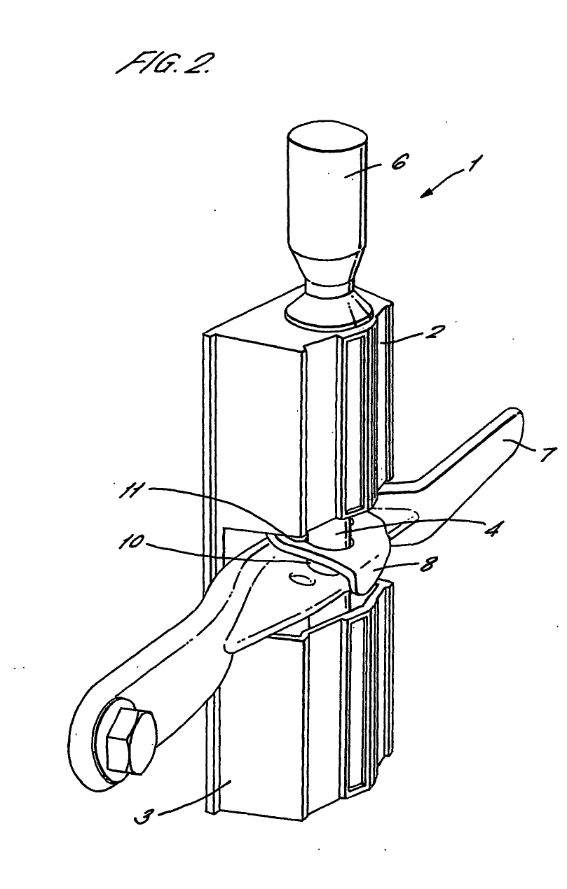

FIG. 3 is a cross-sectional view of an upper housing of the security device of FIG. 1;

FIG. 4 is a further cross-sectional view of the upper housing of FIG. 3;

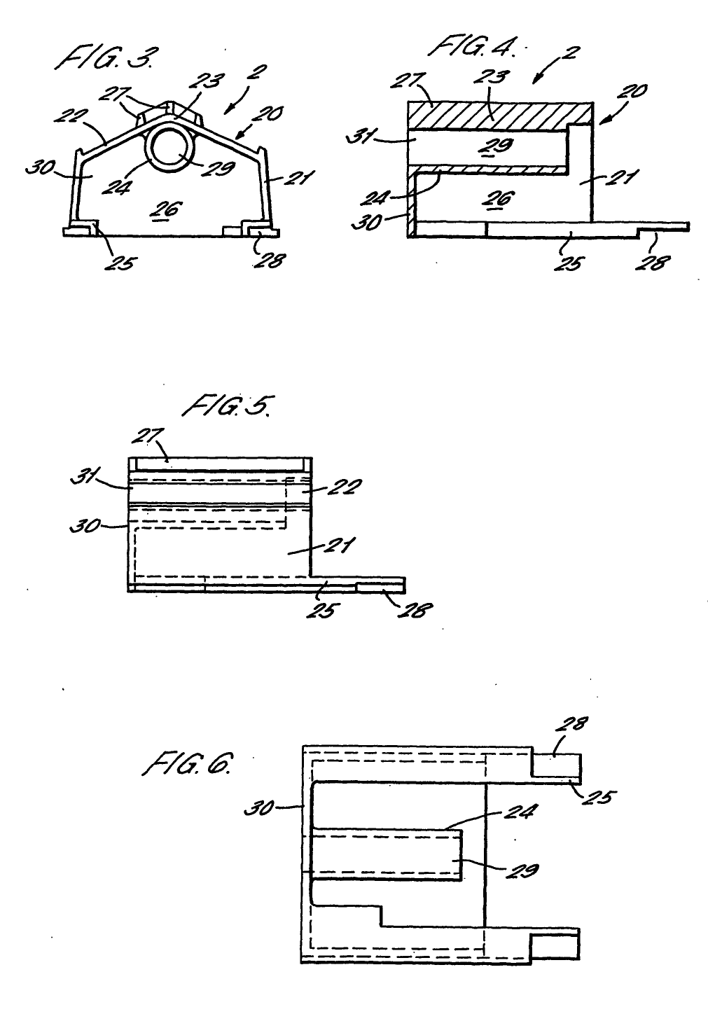

FIG. 5 is a side elevation of the upper housing of FIG. 3;

FIG. 6 is an underneath plan view of the upper housing of FIG. 3;

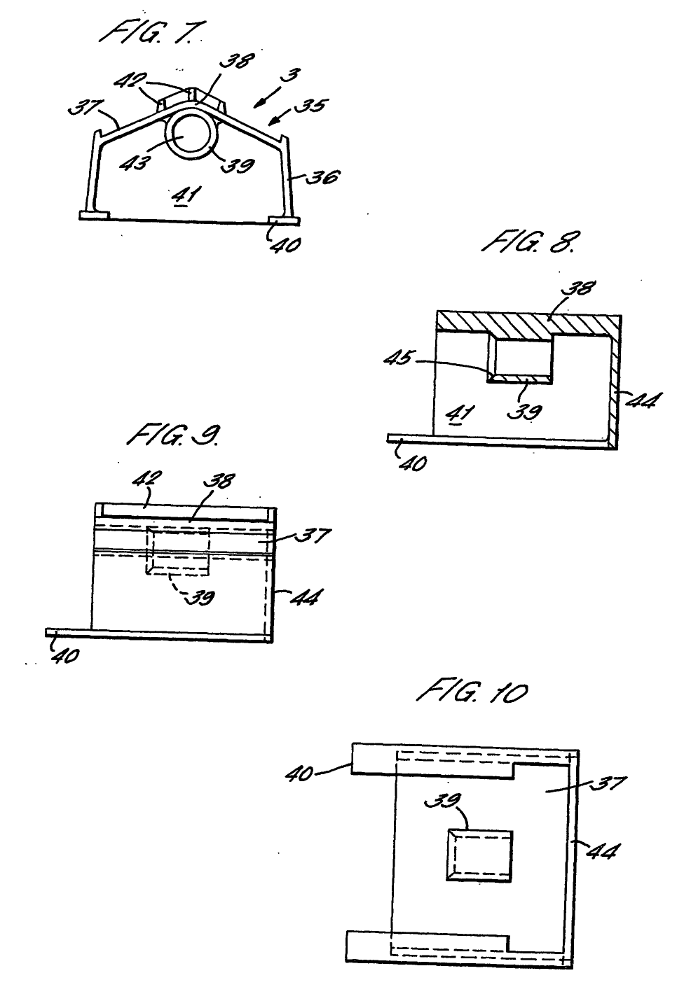

FIG. 7 is a cross-sectional view of a lower housing of the security device of FIG. 1;

FIG. 8 is a further cross-sectional view of the lower housing of FIG. 7;

FIG. 9 is a side elevation of the lower housing of FIG. 7;

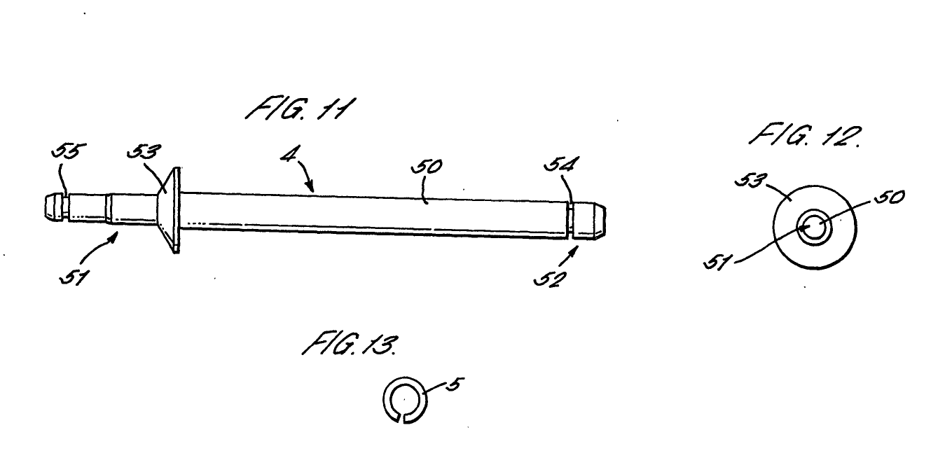

FIG. 10 is an underneath plan view of the lower housing of FIG. 7;

FIG. 11 is a side elevation of a bolt of the security device of FIG. 1;

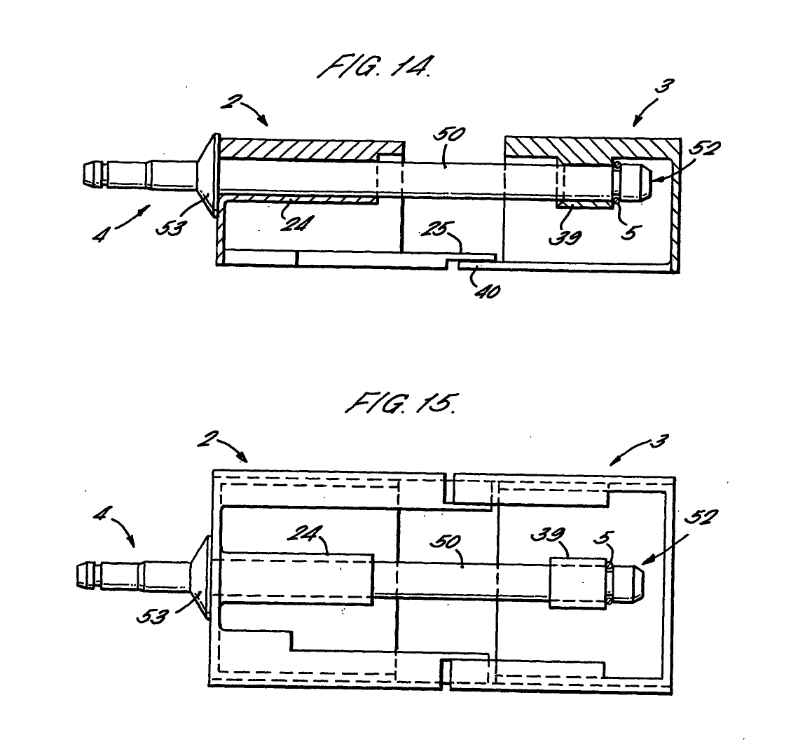

FIG. 12 is an end elevation of the bolt of FIG. 11;

FIG. 13 is a top plan view of a circlip of the security device of FIG. 1;

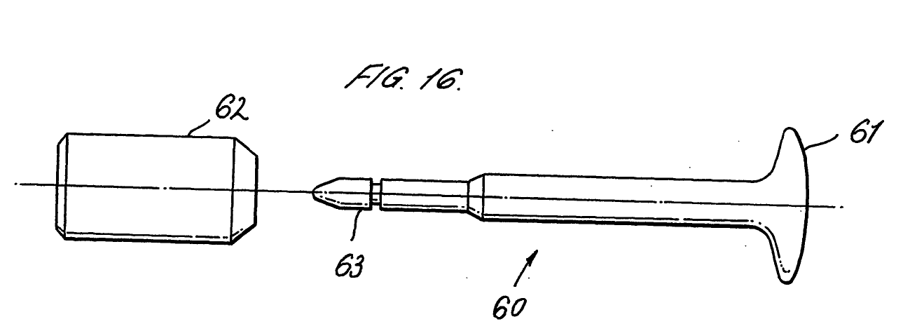

FIG. 14 is a cross-sectional view of the security device of FIG. 1 in a secured configuration;

FIG. 15 is an underneath plan view of the security device in the condition shown in FIG. 14; and

FIG. 16 is a perspective view of a prior art security device in an open configuration.

The security device of the present invention is shown in FIGS. 1 to 15. As shown in FIG. 1, the security device 1 generally comprises an upper housing 2, a lower housing 3, a bolt 4 having a circlip 5 attached thereto and an optional identification tag 6, as shown in FIG. 2.

The upper housing 3 is shown in more detail in FIGS. 3 to 6 and comprises a main body 20 having two side walls 21 and a roof 22 defining an interior 26 of the main body 20. A cylindrical support 24 is located within the interior 26 near an apex 23 of the roof 22 as shown in FIG. 3. The cylindrical support 24 is hollow and defines an internal bore 29 which passes through the length of the support 24 and terminates at an aperture 31 located in an upper wall 30 as shown in FIG. 4. The roof 22 is provided with a number of strengthening ribs 27 which run along the length of the roof 22 parallel to the walls 21. Two locating legs 25 are provided at distal ends of the side walls 21 remote from the roof 22. As shown in FIG. 4, the locating legs 25 extend axially beyond the end of the side walls 21 so as to protrude therefrom. A recess 28 is formed at the end of each locating leg 25.

The lower housing 3 is shown in detail in FIGS. 7 to 10 and, similar to the upper housing 2, comprises a main body 35 having side walls 36 and a roof 37 defining an interior 41. A lower end of the lower housing 3 is closed off by a lower wall 44. A cylindrical barrel 39 is located within the interior 41 attached to the roof 37 near an apex 38 as shown in FIG. 7. The cylindrical barrel 39 is shorter than the cylindrical support 25 of the upper housing. The cylindrical barrel 39 is hollow and defines an internal bore 43. The bore 43 comprises a tapered portion 45 at an end facing away from the lower wall 44 as shown in FIG. 8.

Two locating legs 40 are provided at the distal end of the side walls 36 and extend axially beyond the extent of the side walls 36. As with the upper housing 2, strengthening ribs 42 are provided which run along the roof 37 parallel to the side walls 36.

Both the upper housing 2 and lower housing 3 are made from a sturdy material such as metal. The metal may be steel or other alloy such as an aluminium-based alloy or zinc-based alloy. The upper housing 2 and lower housing 3 may each be formed as a moulded component or formed by cold forming, sintering, the welding of sub-components, or other similar processes.

The cylindrical support 24 and the cylindrical barrel 39 may be formed integrally with the respective upper housing 2 and lower housing 3 where the component is moulded or alternatively, may be fixedly attached to the upper housing 2 and lower housing 3 respectively by welding, soldering, gluing or other similar process.

The bolt 4 of the security device 1 is shown in more detail in FIGS. 11 and 12. The bolt 4 comprises an elongate shaft 50 having an upper end 51 and a lower end 52. A flange 53 is provided near the upper end 51. The upper end 51 is also provided with a circumferential groove 55. The lower end 52 of the shaft 50 is also provided with a cylindrical groove 54.

The circlip 5 is shown in FIG. 13.

To assemble the security device 1, the bolt 4 is first inserted into the upper housing 2 by inserting the elongate shaft 50 into the aperture 31 of the upper housing 2. The elongate shaft 50 is received in the cylindrical support 24 with the elongate shaft 50 extending through the upper housing 2 and protruding therefrom as shown in FIG. 1. The flange 53 of the bolt 4 contacts and abuts the upper wall 30 of the upper housing 2 restricting and preventing the bolt 4 passing completely through the upper housing 2. Preferably, the bolt 4 may be fixed to the upper housing 2 once the bolt has been inserted into the cylindrical support 24. This fixing process may be achieved by welding the flange 53 to the upper wall 30 or by similar means.

Once the bolt 4 has been inserted into the upper housing 2, the circlip 5 is inserted into the groove 54 located near the lower end 52 of the elongate shaft 50. The security device 1 is now ready to be secured to a handle of a cargo container or similar article.

To secure the security device 1, the lower housing 3 and upper housing 2 are brought together around the handle 7 as shown in FIG. 2 such that the S lower end 52 of the elongate shaft 50 extends through the apertures 10 and 11 in the handle 7 and clasp 8 and is received in the cylindrical barrel 39 of the lower housing 3. The lower end 52 of the elongate shaft 50 is able to pass through the bore 43 of the cylindrical barrel 39 by compression of the circlip 5 within the groove 54. Entry of the lower end 52 into the cylindrical barrel 39 and compression of the circlip 5 is encouraged by the tapered portion 45 of the cylindrical barrel 39 which urges the circlip 5 into a compressed state when an axial force is applied.

Once the groove 54 of the elongate shaft 50 and the circlip 5 have passed beyond the end face of the cylindrical barrel 39 the circlip 5 recovers to its original orientation by expanding outwardly and thus preventing retraction of the elongate shaft 50 through the cylindrical barrel 39.

At the same time, the locating legs 25 and 40 of the upper housing 2 and lower housing 3 mate together to ensure that the upper housing 2 and lower housing 3 are kept rotationally aligned with one another. As shown in FIG. 2 and FIGS. 14 and 15, the distal ends of the locating legs 40 of the lower housing 3 are received within the recesses 28 of the locating legs 25 of the upper housing 2.

An identification tag or seal 6 may be fixed to the upper end 55 of the bolt 4 as shown in FIG. 2. The identification tag 6 is secured to the upper end 51 by engagement of the groove 55 of the bolt 4 with an internal structure of the identification tag 6 which is not shown in the drawings but is well-known in the art.

In the secured position as shown in FIG. 2, the security device 1 prevents operation of the handle 7 of the cargo container door since the bolt 4 passes through the apertures 11 and 10 respectively of the clasp 8 and the handle 7.

To remove the security device 1 from the handle 7 of the cargo container, it is necessary to shear through the elongate shaft 50 of the bolt 4. Unlike in prior art devices, an advantage of the security device of the present invention is that tampering with the identification tag 6 alone will not result in removal of the security device 1. The upper housing 2 and lower housing 3 together shroud the locking means of the circlip 5 and the cylindrical barrel 39 preventing tampering therewith. Instead, the only method of opening the security device is by shearing of the elongate shaft 50, for example, with bolt cutters, at which point the upper housing 2 and lower housing 3 may be moved apart to remove the bolt 4 from the apertures 10 and 11 of the handle 7 and clasp 8 allowing the clasp 8 to be opened and the handle 7 to be operated. The sheared bolt shaft 50 cannot easily be glued together or arranged to make it appear that no tampering has taken place.

Another particular advantage of the security device 1 of the present invention is that the upper housing 2 and lower housing 3 in the secured position shown in FIG. 2 shroud the bolt 9 which retains the clasp to the cargo container door. This prevents tampering with the bolt 9 of the cargo container door and thus removal of the clasp 8 which would otherwise circumvent the securing of the handle 7. The shrouding of the handle 7 and clasp 8 also serves to protect the handle 7 and clasp 8 from attack by blunt objects such as hammers and crowbars whilst providing sufficient access room to allow insertion of a pair of bolt cutters.

The security device 1 may be made as a disposable device intended to be used only once. Alternatively, the upper housing 2 and lower housing 3 may be designed to be reusable with only the bolt 4 and circlip 5 being replaced after each use.

In the above description parts of the security device 1 has been described with descriptors such as “upper” or “lower”. However, the security device 1 can be secured in any desired orientation and these descriptors should not be seen as limiting on the present invention. For example, the security device 1 could be secured in an inverted orientation compared to that shown in FIG. 2.

1. A security device for securing a handle to a clasp so as to prevent operation of said handle, the security device comprising a first housing having a bolt extending therefrom and a second housing comprising retaining means for receiving and retaining a distal end of the bolt to secure the first and second housings together;
in a first state the first and second housings being separate from each other and separate from said handle to which the security device is to be secured;
the first and second housings being assemblable into a second state in which the first and second housings are secured together by means of engagement of the bolt with the retaining means, wherein, in use, in the second state the security device may enclose at least a portion of said handle within an interior of the security device and wherein the bolt may pass through an aperture in the handle and an aperture in the clasp;
wherein, in use, in the second state the second housing shrouds the retaining means and wherein, in use, in the second state the first and second housings shroud the clasp.

2. A security device as claimed in claim 1 wherein the clasp to which the security device is to be secured is of a type which is fixed to a structure, such as a door, by means of fixing, wherein in the second state, in use, the first and second housings shroud the fixing of the clasp.

3. A security device as claimed in claim 1 wherein the retaining means comprises a barrel located in the second housing, the bolt comprising a locking means in the form of a retaining ring located on the bolt and wherein passage of the retaining ring through the barrel is accommodated in only one direction.

4. A security device as claimed in claim 1 wherein in the second state with the first and second housings secured together, the interior is bounded by an upper wall, a lower wall, side walls and a roof.

5. A security device as claimed in claim 1 wherein in the second state with the first and second housings secured together the first and second housings delimit an aperture through which, in use, shearing means may be brought into engagement with the bolt.

6. A security device as claimed in claim 5 wherein, in use, at least a portion of the handle to be secured can extend from an exterior of the security device through the aperture into the interior of the first and second housings into engagement with the bolt.

7. A security device as claimed in claim 1 wherein the first housing and bolt are secured together.

8. A security device as claimed in claim 1 wherein the first and second housings comprise inter-engaging means to prevent relative rotation of the first and second housings about the bolt.

9. A security device as claimed in claim 1 wherein the first and second housings are axially slidable relative to one another to secure the first and second housings together.

10. A security device as claimed in claim 1 further comprising an identification tag.

11. A method of securing a handle to a clasp comprising engaging a first housing and a second housing around at least a portion of the handle, wherein a bolt of the first housing is passed through at least one aperture formed in the handle and at least one aperture formed in the clasp and engaged in retaining means located in the second housing to secure the first and second housings together, wherein securement of the first and second housings together shrouds the retaining means and clasp.

12. Use of the security device of any of claims 1 to 10 to secure a handle.

13. The use of claim 12 wherein the handle is the handle of a cargo container door.

14. The use of claim 13 wherein the bolt of the security device is passed through at least one aperture in the handle.

15. (canceled)
